(19) United States
(12) Patent Application Publication
(10) Pub. No.: US 2005/0041433 A1
(43) Pub. Date: Feb. 24, 2005

(54) Automotive lighting system

(75) Inventor: Edwin Mitchell Sayers, Saline, MI (US)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/642,887

(22) Filed: Aug. 18, 2003

(51) Int. Cl. B60Q 1/00

(52) U.S. Cl. 362/459

(57) ABSTRACT

The present invention is an automotive lighting system including semiconductor laser sources, optical waveguides, and focusing assemblies for generating, transmitting, and directing light for a variety of automotive applications. In particular, the present invention includes phosphor-based semiconductor lasers integrated into an automotive lighting system that is usable for producing white light in close proximity to a focusing assembly, or remotely from the focusing assembly through a network of optical waveguides in a distributive lighting system.

### BACKGROUND

### Technical Field

The present invention pertains to the field of illumination, and more particularly to lighting systems for automotive vehicles.

### BRIEF SUMMARY

Numerous efforts have been made to increase the safety, reliability and efficiency of motor vehicles and aircraft while reducing the overall cost of manufacturing. Essential to meeting these goals is incorporating new and expanding technologies into the manufacturing process and the vehicle itself. Optical technology has offered many benefits by providing more efficient and more reliable light sources than were previously available. Specifically, efforts have been made to provide alternative lighting systems, which substantially reduce the number of light sources in vehicle lighting systems. These systems reduce the vehicle's electrical load and thereby providing a power budget for other vehicle features. Styling may also be differentiated through the use of systems that enable different appearances and packages. Suitable alternative light sources include solid state lasers, also known as laser diodes or semiconductor lasers.

Illuminating devices of the above-mentioned general type are known in the art. A representative illuminating device has several semiconductor light sources in the form of light diodes. The light diodes may be three-phase light diodes which, depending on electrical control and configuration can emit light in at least two different colors. With this illuminating device it is possible to emit light with at least two different wavelength bands (evidenced by differing color), and all light diodes emit light of the same color. With such a construction the illuminating device can be used for different illuminating and signaling functions. Utilization of this illuminating device within a headlamp is complicated since the light diodes do not emit white light, but instead they emit red, green and blue light, which must be modulated in such a way as to blend the light over time, switching colors faster than the eye response. Moreover, the three-phase light diodes are more expensive than simple semiconductor light sources, which emit light of one color. Also, the control of the three-phase light diodes requires a higher expense so that this illuminating device is expensive in both its manufacture and operation.

Other alternative lighting systems have incorporated an array of semiconductor lasers that emit light of different wavelengths. The light emitted from the array is blended and directed by systems of optical fibers or other optical components. While this type of system can provide generally white light, it presents an inefficient means for mixing the distinct colors of the semiconductor laser array. As such, there is a need in the art for an inexpensive and easy-to-operate lighting system that improves upon the benefits of laser diode technology.

Accordingly, the present invention is an automotive lighting system including semiconductor laser sources, optical waveguides, and focusing assemblies for generating, transmitting, and directing light for a variety of automotive applications.

In particular, the present invention includes semiconductor laser sources that may be laser diodes generating a single wavelength of laser light. Alternatively, the present invention includes epitaxial semiconductor structures that incorporate at least two separate laser diodes in close proximity for generating substantially white light from a single structure. Also described are phosphor-based laser sources that include a semiconductor laser source having a phosphor layer deposited in the direction of propagation, thereby generating white light through phosphorescence.

The optical waveguides include optical fibers and optical fiber bundles, and the terms may be used interchangeably herein. The optical waveguides may be coupled directly to a single laser source emanating a single-color laser, to a single laser source emanating a multi-color laser, or to a phosphor-based source that emanates white light. The optical waveguides allow for great flexibility in packaging the lighting system in an automobile, as the light source may be located remotely from the focusing assembly. For example, an array of semiconductor lasers can be disposed in a remote location, for example in the engine compartment, and the optical waveguides can transmit light from the lasers to the headlamps and the taillights of the vehicle.

The focusing assembly includes various optical components such as reflectors, refractors, lenses and filters that may be used to adjust the color, intensity, and direction of the light passing into and from the optical waveguides. In one embodiment, the focusing assembly may be headlamp optical components designed so as to fulfill the low-beam parameters set forth by the Society of Automotive Engineers (SAE).

These and numerous other features and advantages of the present invention are made more apparent through the detailed description of the preferred embodiment which follows.

### BRIEF DESCRIPTION OF THE DRAWINGS

FIG. 1 is a schematic representation of an automotive lighting system including an epitaxial semiconductor laser emitting three wavelengths in accordance with one embodiment of the present invention.

FIG. 2 is a perspective view of an epitaxial semiconductor laser emitting two wavelengths in accordance with one embodiment of the present invention.

FIG. 3 is a perspective view of a single-wavelength phosphor-based laser source for emitting light at the semiconductor junction in accordance with one embodiment of the present invention.

FIG. 4 is a perspective view of a single wavelength phosphor-based surface-emitting laser source in accordance with one embodiment of the present invention.

FIG. 5 is a perspective view of a laser source coupled to a shaped optic in accordance with one embodiment of the present invention.

FIG. 6 is a perspective view of a laser source coupled to a second shaped optic in accordance with an alternative embodiment of the present invention.

FIG. 7 is a schematic view of an automotive vehicle incorporating the automotive lighting system of the present invention.

### DETAILED DESCRIPTION OF THE DRAWINGS AND THE PRESENTLY PREFERRED EMBODIMENTS

The following description pertains to an improved automotive lighting system including semiconductor laser sources, optical waveguides, and focusing assemblies for generating, transmitting, and directing light for a variety of automotive applications.

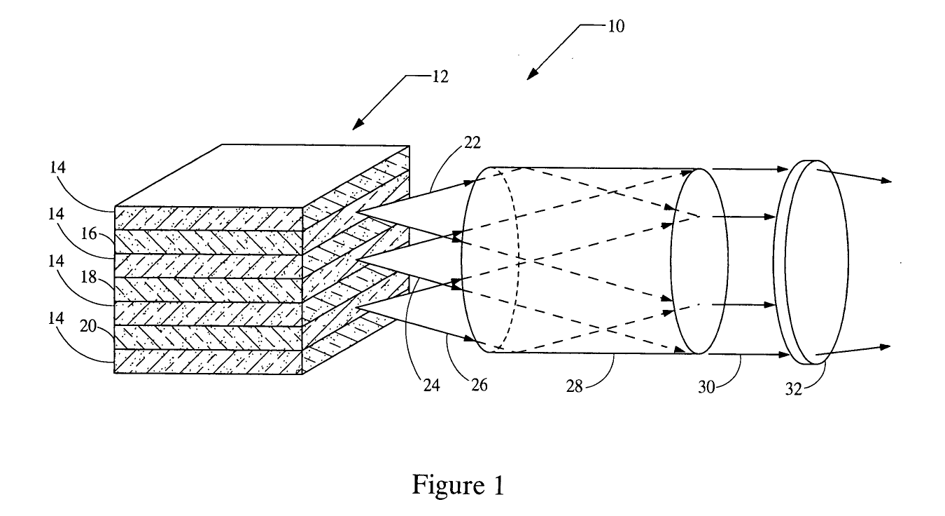

Referring to FIG. 1, a schematic view of the automotive lighting system 10 of the present invention is shown. A semiconductor laser 12 emits laser light into an optical waveguide 28 which transmits the light to a focusing assembly 32, shown here for example as a lens. The semiconductor laser 12 emits light of distinct frequencies, which is blended and transmitted by the optical waveguide 28, which directs the light to the focusing assembly 32 for automotive application.

As shown, the semiconductor laser 12 is an epitaxial structure, which consists of multiple layers having distinct semiconductive properties. A series of inert layers 14 alternates with active layers, including a first layer 16, a second layer 18, and a third layer 20. The first, second, and third layers 16, 18, 20 themselves may consist of more than one semiconductor layer and form a laser diode.

In one embodiment, the first layer 16 emits, for example, red laser light 22. The second layer 18 may emit green laser light 24, and the third layer 20 may emit blue laser light 26. Accordingly, the semiconductor laser 12 shown in FIG. 1 includes three separate laser sources that are fabricated into one epitaxial structure. The semiconductor laser 12 is specifically designed such that the inert layers 14 are of minimal thickness such that the first, second, and third layers 16, 18, 20 are optically indiscernible from each other, a feature that increases the efficiency and consistency of the light mixing.

In one embodiment, the inert layers 14 are materials having a lower index of refraction relative to the first, second, and third layers 16, 18, 20, thereby creating an index-guided epitaxial semiconductor laser 12. Alternatively, the inert layers 14 are a non-gain medium such that the laser gains are isolated to the first, second, and third layer 16, 18, 20, a gain guided epitaxial structure. As noted, the inert layers 14 are of minimal thickness to ensure that the red laser light 22, the green laser light 26, and the blue laser light 28 near the emitting surface of the semiconductor laser 12.

The semiconductor laser 12 is coupled to an optical waveguide 28, such as an optical fiber or an optical fiber bundle. The optical waveguide 28 serves multiple purposes, most notably the transmission of the laser light to the focusing assembly 32. In one embodiment, red laser light 22, green laser light 24, and blue laser light 26 are all channeled into the optical waveguide 28 wherein the respective laser colors blend into a white light 30 that is emitted from the optical waveguide 28. Alternatively, each of the red laser light 22, green laser light 24, and blue laser light 26 could be directed into a separate optical waveguide 28, for example, as part of an optical fiber bundle. In the latter example, the distinct colors are blended after transmission through the optical waveguide 28.

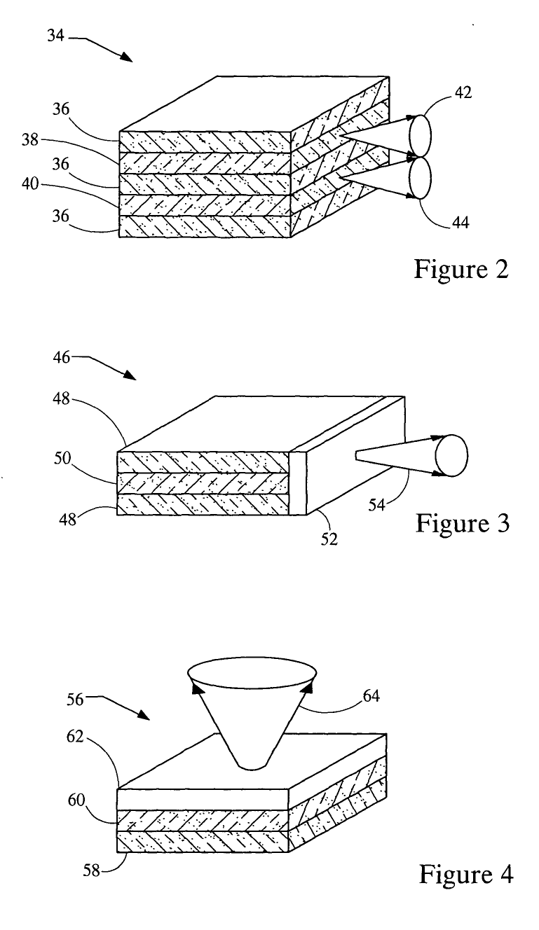

As shown in FIG. 2, a second embodiment of the semiconductor laser 34 is a bi-color epitaxial semiconductor laser is shown separate from the waveguide with which it will be used. As described above, a series of inert layers 36 bound each of a first layer 38 and a second layer 40. In one embodiment, the first layer 38 emits laser light 42 that is red and the second layer 40 emits laser light 44 that is blue-green or Cyan. In another embodiment, the first layer 38 emits laser light that is yellow and the second layer 40 emits laser light 44 that is blue.

As noted above, the inert layers 36 may be materials having a lower index of refraction relative to the first and second layers 38, 40 thereby creating an index-guided epitaxial semiconductor laser 34. Alternatively, the inert layers 36 are a non-gain medium such that the laser gains are isolated to the first and second layers 38, 40, a gain guided epitaxial structure. As before, the inert layers 36 are of minimal thickness to ensure that the respective laser light 42, 44 emitted by the semiconductor laser 34 is readily blended.

FIG. 3 is a perspective view of a preferred semiconductor laser 46 for use in the automotive lighting system of the present invention according to a third embodiment, also illustrated separate from a waveguide with which it would be used. The semiconductor laser 46 is a phosphor-based light source including an active layer 50 disposed between a pair of inert layers 48. The active layer 50 may be comprised of more than one layer, as is typical of laser diodes.

The semiconductor laser 46 emits light (not shown) parallel to the junction of the active layer 50 and the inert layers 48. The active layer 50 emits blue laser light or, alternatively, ultraviolet (UV) laser light. A phosphor layer 52 is deposited on the edge of the semiconductor laser 46 such that laser light emitted from the semiconductor laser 46 must interact with the phosphor layer 52. The interaction, phosphorescence, produces a substantially white light 54 suitable for a host of applications.

The phosphor layer 52 material depends upon the wavelength of light emitted by the active layer 50. If the active layer 50 emits blue light, then the phosphor layer 52 would be selected to emit a substantially yellow-orange broad-band light when excited. The combination of the blue light from the active layer 50 and the yellow-orange light from the phosphor layer 52 would produce a white light 54.

Alternatively, if the active layer 50 emits UV laser light, then the phosphor layer 52 would be selected such that it is a tri-color phosphor, emitting red, green, and blue light when excited. The UV laser light from the active layer 50 acts as a pump to stimulate the emission of red, green, and blue light from the phosphor layer 52. The combination of the red, green, and blue light produces a white light 54.

FIG. 4 is a perspective view of a surface-emitting semiconductor laser 56 in accordance with another preferred embodiment of the present invention. The semiconductor laser 56 is a phosphor-based light source including an active layer 60 disposed on an inert layer 58, such as a substrate. The active layer 60 may be comprised of more than one layer, as is typical of laser diodes.

The semiconductor laser 56 emits light (not shown) along a direction normal to the surface of the active layer 60, as is known for surface-emitting laser diodes. The active layer 60 emits either blue laser light or UV laser light, as needed by application. A phosphor layer 62 is deposited on the surface of the active layer 60 such that light emitted from the active layer 60 must interact with the phosphor layer 62. The phosphorescent interaction produces a substantially white light 64 suitable for a host of automotive applications.

As before, the phosphor layer 62 material depends upon the wavelength of light emitted by the active layer 60. If the active layer 60 emits blue light, then the phosphor layer 62 would be selected to emit a substantially yellow light when excited. Alternatively, if the active layer 60 emits UV laser light, then the phosphor layer 62 would be selected such that it is a tri-color phosphor, emitting red, green, and blue light when excited. In both instances, the net result is a color combination that creates white light 64.

In accordance with alternative embodiments of the present invention as described above, it may be advantageous to implement a shaped optic for distributing and focusing the laser light. In preferred embodiments, the optic may be shaped for large scale beam focusing, or alternatively, the optic may be a smooth lens with fine-grade surface features that better distribute the laser light.

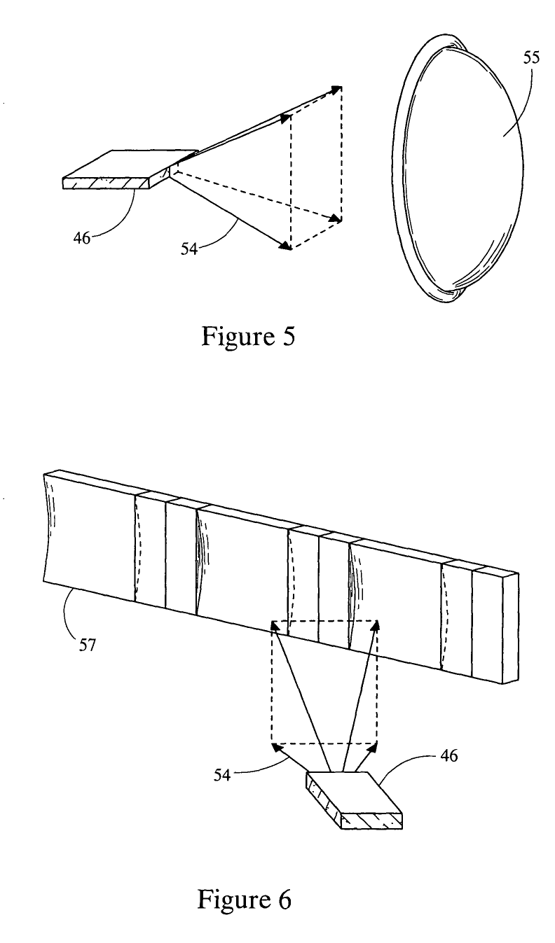

For example, FIG. 5 is illustrative of an embodiment in which the laser source 46 emits white light 54 in the direction of a shaped optic 55. In the particular embodiment shown, the optic 55 is an asphere. In a preferred embodiment, the optic 55 is an asphere of several different sections so as to produce a desired beam pattern, such as the SAE low beam pattern.

In FIG. 6, the optic 57 shown is a portion of a smooth lens having fine-grade surface features. In this example, the optic 57 has alternating straight and annular surfaces that cooperate to produce the desired beam pattern, such as the SAE low beam pattern.

Each of the optics 55, 57 shown in FIGS. 5 and 6 are readily adaptable for use in the automotive lighting system 10 shown in FIG. 1.

The automotive lighting system 10 shown in FIG. 1 and further described in FIGS. 2 through 6 can be integrated into an automotive vehicle to create a remote lighting system (RLS).

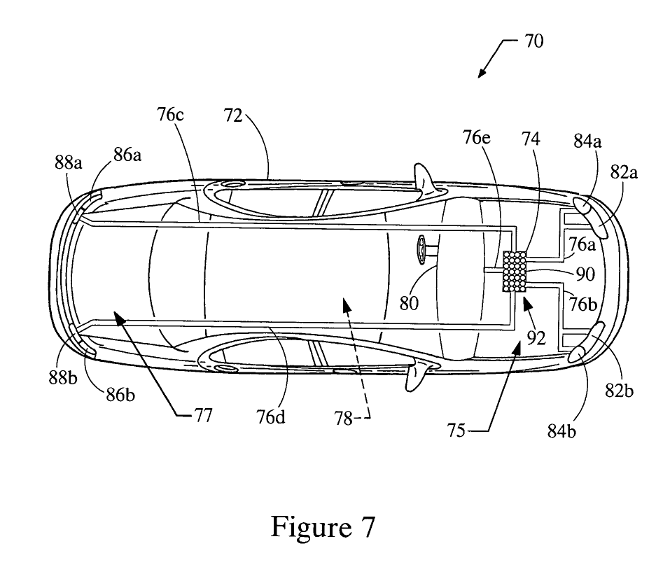

FIG. 7 is a schematic view of such a remote lighting system 70 integrated into an automotive vehicle 72. The remote lighting system 70 includes a light generator 74 incorporating at least one semiconductor light source, generally designated as 90, as described above in FIGS. 1-4. The light generator 74 is coupled to a network of optical waveguides 76a, 76b, 76c, 76d, 76e that collect, direct, and transmit laser light from the light bank 74 to focusing assemblies of the automotive vehicle 72, as described further herein.

For example, in order to provide forward lighting the light generator is coupled to optical waveguides 76a, 76b which are directed towards the forward portion 75 of the automotive vehicle 72. Optical waveguide 76a is coupled, for example, to a headlight 82a and/or a turn signal 84a. Similarly, optical waveguide 76b is coupled, for example, to a headlight 82b and/or a turn signal 84b.

To provide rear lighting, optical waveguides 76c, 76d are directed towards the rearward portion 77 of the automotive vehicle 72. As an example, optical waveguide 76c is coupled to a turn signal 86a and/or a taillight 88a, and optical waveguide 76d is coupled to a turn signal 86b and/or a taillight 88b. Optical waveguides 76a, 76b may also be coupled to brake light assemblies (not shown), that may be located at various positions in the rearward portion 77 of the automotive vehicle 72.

Interior lighting is provided to the passenger compartment 78 of the automotive vehicle 72 via optical waveguide 76e. For example, optical waveguide 76e may be coupled to an instrument panel 80 located within the passenger compartment 78. In further embodiments, the optical waveguide 76e may be coupled to a number of lighting subsystems within the passenger compartment 78, such as ambient lighting and warning lights.

In its preferred embodiments, the remote lighting system 70 includes a light bank 74 that contains an array 92 or system of semiconductor lasers. Most preferably, the semiconductor lasers are selected from a group of the phosphor-based lasers described herein with reference to FIGS. 3 and 4. In order to provide superior lighting quality, the semiconductor laser 56 of FIG. 4 emitting UV light into a tri-color phosphor layer 62 provides consistent and pure white light 64 for use in a multitude of automotive lighting applications.

As described, the present invention is an automotive lighting system including semiconductor laser sources, optical waveguides, and focusing assemblies for generating, transmitting, and directing light for a variety of automotive applications. Although the present invention has been described with reference to certain preferred embodiments, it is understood that various modifications can be made by one skilled in the art without departing from the scope of the present invention as defined in the following claims.

It is therefore intended that the foregoing detailed description be regarded as illustrative rather than limiting, and that it be understood that it is the following claims, including all equivalents, that are intended to define the spirit and scope of this invention.

It is therefore intended that the foregoing detailed description be regarded as illustrative rather than limiting, and that it be understood that it is the following claims, including all equivalents, that are intended to define the spirit and scope of this invention.

1. An automotive lighting system comprising:
a semiconductor laser light source adapted to emit laser light of at least one wavelength;
an optical wave guide coupled to the semiconductor laser light source to guide and blend the laser light; and
a focusing assembly coupled to the optical wave guide to direct the laser light.

2. The automotive lighting system of claim 1 wherein the semiconductor laser light source is an epitaxial structure including two light-emitting layers, the two-light emitting layers emitting light of distinct frequencies.

3. The automotive lighting system of claim 2 wherein the two light-emitting layers are gain-guided waveguides.

4. The automotive lighting system of claim 2 wherein the two light-emitting layers are index-guided waveguides.

5. The automotive lighting system of claim 2 wherein a first of the two light-emitting layers emits light corresponding to a red wavelength, and further wherein a second of the two light-emitting layers emits light corresponding to a blue-green (Cyan) wavelength.

6. The automotive lighting system of claim 2 wherein a first of the two light-emitting layers emits light corresponding to a yellow wavelength, and further wherein a second of the two light-emitting layers emits light corresponding to a blue wavelength.

7. The automotive lighting system of claim 1 wherein the semiconductor laser light source is an epitaxial structure including three light-emitting layers, the three-light emitting layers emitting light of distinct frequencies.

8. The automotive lighting system of claim 7 wherein the three light-emitting layers are gain-guided waveguides.

9. The automotive lighting system of claim 7 wherein the three light-emitting layers are index-guided waveguides.

10. The automotive lighting system of claim 7 wherein a first of the three light-emitting layers emits light corresponding to a red wavelength, and further wherein a second of the three light-emitting layers emits light corresponding to a green wavelength, and further wherein a third of the three light-emitting layers emits light corresponding to a blue wavelength.

11. A light source for use in an automobile comprising:
a semiconductor laser defining an emitting surface and adapted to emit laser light of a predetermined wavelength;
a phosphor layer coupled to the emitting surface of the semiconductor laser such that laser light emitted from the semiconductor layer causes phosphorescence in the phosphor layer, and further such that light including a plurality of frequencies is emitted from the phosphor layer.

12. The light source of claim 11 wherein the semiconductor laser emits laser light corresponding to a blue wavelength.

13. The laser light source of claim 11 wherein the semiconductor laser emits laser light corresponding to an ultraviolet wavelength.

14. The laser light source of claim 11 wherein the phosphor layer is a tri-color phosphor.

15. The laser light source of claim 11 wherein the semiconductor laser emits laser light corresponding to an ultraviolet wavelength, and further wherein the phosphor layer is a tri-color phosphor such that in response to being irradiated by the semiconductor laser, the tri-color phosphor emits substantially white light.

16. A remote lighting system comprising:
a first semiconductor laser emitting laser light of at least one selected wavelength;
a first network of optical waveguides coupled to the semiconductor laser light source to guide and blend the laser light; and
a focusing assembly coupled to the optical wave guide to direct the laser light, the focusing assembly disposed remotely from the plurality of semiconductor laser light sources.

17. The remote lighting system of claim 16 further comprising a second semiconductor laser emitting laser light of a second selected wavelength.

18. The remote lighting system of claim 16 wherein the first network of optical waveguides is a bundle of fiber optic channels.

19. The remote lighting system of claim 16 further comprising a second semiconductor laser emitting laser light of a second selected wavelength wherein the second semiconductor laser is coupled to a second network of optical waveguides, and further wherein the first network of optical waveguides and the second network of optical waveguides are severally coupled to the focusing assembly such that laser light of distinct frequencies is blended in the focusing assembly.

20. The remote lighting system of claim 16 wherein the focusing assembly includes headlamps, taillights, turn signals, and interior lighting for an automotive vehicle.

21. The remote lighting system of claim 16 wherein the focusing assembly includes an optic, and further wherein the optic comprises an aspherical section.

22. The remote lighting system of claim 16 wherein the focusing assembly includes an optic, and further wherein the optic comprises a substantially smooth surface having alternating straight and annular portions.

23. The remote lighting system of claim 16 further comprising an array of semiconductor lasers coupled to at least the first network of optical waveguides, the array of semiconductor lasers including at least the first semiconductor laser.
